(19) United States
(12) Patent Application Publication
(10) Pub. No.: US 2009/0038416 A1
(43) Pub. Date: Feb. 12, 2009

(54) System and method for biological sample collection and analyte detection

(76) Inventor: Aleta Behrman Bonner, Belton, TX (US)

Correspondence Address: David Allen Hall, P.O Box 1540, Blanco, TX, 78606, US

(21) Appl. No.: 12/006,662

(22) Filed: Jan. 5, 2008

Related U.S. Application Data
(60) Provisional application No. 60/954,478, filed on Aug. 7, 2007.

(51) Int. Cl. G01N 1/02

(52) U.S. Cl. 73/864.51

(57) ABSTRACT

A system and method for acquiring biological and chemical samples for determination of the presence of analytes. In some embodiments a system may include a sample receptacle, sample director, sample manipulator, and at least one indicator. In some embodiments a sample receptacle may include a magnifying transparent portion that provides for visualization of the indicator. In some embodiments the director may be configured to conform to various parts of the human or other animal body from which samples are to be taken.

This nonprovisional utility application claims priority from and incorporates by reference U.S. provisional application 60/954,478 filed by the same sole inventor on Aug. 7, 2007.

### BACKGROUND OF THE INVENTION

1. Field of the Invention

The present invention relates to the acquisition of biological and chemical samples and their use for investigation for the presence of analytes.

2. Definitions

Terminology used herein describes particular embodiments only, and is not intended to be limiting. As used in the specification, including the claims, the singular forms “a”, “an”, and “the” include singular and plural referents unless the content dictates otherwise. For example, reference to “a manipulator” includes one or more manipulators. Unless defined otherwise, all technical and scientific terms used herein have meanings commonly understood by one of ordinary skill in the relevant industry.

“Analyte” herein generally refers to a chemical or biological agent. Biological agents include, but are not limited to, viruses, diseases, molds, and living organisms. One example of a chemical agent is lead.

“Animal” herein includes humans.

“Connected” herein generally refers to pieces that may be joined or linked together.

“Coupled” herein generally refers to pieces that may be used operatively with each other or joined or linked together with or without intervening members.

“Directly” herein generally refers to two or more objects in physical contact with each other or a process that affects an object or another process without involvement of intermediate objects or steps.

“Director” and “diverter” herein generally refer to any device designed to direct, divert, or otherwise aim a sample in a desired direction.

“Indicator” herein generally refers to an object having a characteristic that in the presence of a subject of detection changes sufficiently to show the presence of and/or measure such subject.

“Manipulator” herein generally refers to an object maneuvered or controlled by a user to position sample or an indicator in a desired configuration or location.

“Opening” herein generally refers to a point of ingress or egress on an object, or, in the case of a human or other animal, an orifice such as the nose or an opening such as a wound.

“Proximal” and “distal” herein generally refer, respectively, to a point positioned nearest to and furthest from a point of reference. The point of reference herein is the opening of a subject from whence a biological sample is collected.

“Sample” or “biological sample” herein refers to a substance that can be tested for the presence or concentration of a particular component. Examples of liquid samples that may be tested using the present invention include, but are not limited to blood, serum, plasma, saliva, urine, ocular fluid, semen, nasal secretions, mucus, stool, and spinal, wound, or abscess fluid, sewage, milk, wine, and water from oceans, lakes, rivers, homes, factories, and runoff. Viscous fluids and semi-solid or solid specimens, for example paint scrapings, may be used to create liquid solutions, eluates, suspensions, or extracts that may serve as samples. Samples may include any combination of liquids, solids, and gases, and any biological materials including, but not limited to, cells, microbes, organelles, mold, and biochemical complexes. Samples are not limited to a single component and may include additives added for any purpose, for example, a catalyst.

3. Relevant Art

Influenza virus types A and B are common respiratory pathogens in the general and pediatric population. Depending on age, attack rates in the pediatric population may be 1.5 to 3 times higher than for adults, with school-age children having the highest attack rates. A retrospective cohort study of children younger than 15 demonstrated outpatient visits attributable to influenza ranging from 6 to 15 per 100 children. Influenza virus leads to a significant increase in wintertime primary care and emergency department visits.

Rapid diagnostic test kits for influenza types A and B are currently available for outpatient use and have proven to be both sensitive and specific. Few studies that analyze the impact of rapid diagnostic testing for influenza and subsequent effect on patient management have been performed. Rapid diagnostic tests are not currently routinely incorporated in the work-up of infants and children with fever and vague symptoms, or with fever and no documented source. Pediatric emergency departments' use of rapid tests that are sensitive and specific for influenza may potentially decrease the necessity of other more invasive tests, thereby reducing patient cost and length of stay in the emergency department, avoiding unnecessary antibiotic usage, and increasing appropriate antiviral use.

The goal of a 2003 randomized prospective study was evaluation of the effect of knowledge of a positive rapid influenza test on physician decision-making and patient management in the pediatric emergency department. The hypothesis was that physicians would alter their decision-making and subsequent patient management when they were aware of a positive rapid influenza test before patient evaluation. Analysis of all study participants and those 2 to 36 months old was part of the study design. A detailed discussion of this study may be found in Bonner et al. “Impact of the Rapid Diagnosis of Influenza on Physician Decision-Making and Patient Management in the Pediatric Emergency Department: Results of a Randomized, Prospective, Controlled Trial”, Pediatrics, 2003, 112, pp. 363-367, which is herein incorporated by reference.

Physicians knew before initiation of the study that researchers would be evaluating differences in treatment between the aware and unaware groups of patients. There were no physicians who refused to participate in the study. The study hypothesis and specific aims were not discussed with the physicians in an effort to reduce introduction of management and treatment bias between the groups of patients.

Traditional diagnosis of influenza by viral culture or polymerase chain reaction requires too much time to be useful in generating treatment options. Recent advances in technology have led to development of rapid diagnostic tests that are both sensitive and specific for diagnosis of influenza types A and B. To date, rapid diagnostic testing has not been incorporated into guidelines for the evaluation of febrile infants and young children. Lack of physician familiarity with rapid diagnostic test technology, cost of the test, reimbursement issues, and performance of tests in non-Clinical Laboratory Improvement Amendments settings are possible reasons for low usage of these tests.

Morbidity associated with influenza is primarily in the form of upper and lower respiratory tract disease. Otitis media, a common finding with influenza infection, occurs in 20% to 42% of children. Children with influenza often appear quite ill and present with a variety of symptoms. In the setting of the emergency department, ill-appearing infants and children with fever and vague symptoms often undergo extensive testing to rule out serious bacterial illnesses such as bacteremia, pneumonia, meningitis, and urinary tract infection. Complete blood counts, urinalyses, blood cultures, lumbar punctures, and radiographs are frequently performed, especially in infants and younger children. These tests can significantly increase patient cost and length of stay in the emergency department. One retrospective study demonstrated that fewer complete blood counts and urinalyses were ordered when patients were known to be influenza-positive before discharge from the emergency department. Bonner's study confirmed a significant reduction in tests ordered and total cost when the physician had knowledge of the influenzapositive result. This was true for all study participants as well as the subgroup of patients 2 to 36 months of age.

Several studies have shown that patients with documented influenza infection have fewer antibiotics administered, thus reducing indiscriminant antibiotic use. Decreased side effects and reduction in emergence of antibiotic resistance would naturally follow. Other investigators have demonstrated even further reduction in antibiotic use with appropriate diagnosis of influenza and use of antiviral agents early in the disease course. Bonner observed statistically significant differences in tests ordered and costs, and demonstrated a significant decrease in antibiotic prescriptions between the influenza-positive groups where the differentiating variable between them was physician knowledge of the test result. Subgroup analysis of the 2 to 36 month age influenza-positive groups for antibiotic prescriptions also reached statistical significance. Increasing pressure to decrease inappropriate antibiotic usage makes diagnosis of viral illness more important.

Bonner's study demonstrated that physician knowledge of rapid diagnostic test results for influenza positive pediatric patients resulted in significant alteration of physician decision-making and illness management. Rapid diagnosis of influenza and physician knowledge of the result increased subsequent antiviral use and significantly reduced the number of tests performed, antibiotic use, length of stay in the emergency department, and patient cost.

U.S. Pat. No. 6,967,084 relates to a simple method for the differential diagnosis of allergies, sinusitis, and upper respiratory tract infections. The method involves the use of either commercially available or novel, specifically adapted, indicator or reagent test strips that are contacted with nasal secretions. Based on the differential read-out from the indicator strip, and a measure of eosinophil infiltration or other substance in the nasal secretion, a user of the strip is able to determine whether an allergic condition, a viral infection, or bacterial sinusitis is the cause of the respiratory discomfort. This invention provides a device for providing differential diagnosis whereby a patient may easily deposit nasal secretions on the indicator elements by blowing his nose into a container, such as a bag in which the indicator device may be inserted, or of which the indicator element forms an integral part.

U.S. Pat. No. 4,663,277 relates to a method for detecting a virus by means of an immunoassay in which an extended solid phase coated with antiviral antibody is employed to bind and remove virions from a specimen by forming an immuno-complex with antigens of said virions, or a mobile solid phase comprising a dispersion of microspheres coated with the antiviral antibody is used to bind the microspheres to antigens associated with the immuno-complex, and the presence of bound microspheres is detected. The detection sensitivity is amplified by using microspheres comprising a dye or a label. The extended solid phase may be in the form of a dipstick, syringe, tube, or container that can be brought into contact with the specimen. A virus detection kit provides the extended solid phase and mobile solid phases, each coated with antiviral antibodies.

U.S. Pat. No. 4,663,277 discloses a method for detection of viruses in a specimen and includes the steps of i) treating the specimen to remove undesired components, ii) contacting the specimen with a solid phase support having conjugated thereto antiviral antibody capable of forming immuno-complexes with antigens characteristic of the viruses to be detected, iii) separating the solid phase support from the specimen, iv) contacting the separated solid phase support with a mobile solid phase consisting of dispersed microspheres smaller than 0.1 micromolar and labeled with metal elements and having conjugated thereto the antiviral antibody that enables the binding of said microspheres to said immuno-complexes, v) separating the unbound mobile solid phase from the solid phase support, and vi) measuring the presence of microspheres bound to said solid phase support by X-ray fluorescence, thereby detecting or determining the presence of viruses in said specimen.

U.S. Pat. No. 4,740,467 discloses a method for diagnosing syphilis and other treponematoses infections such as yaws and pinta. The method involves admixing a biological sample, such as lesion exudate, cerebrospinal fluid, serum, urine, amniotic fluid, synovial fluid, or tissue homogenate from a person suspected of having syphilis, yaws, or pinta together with a reagent of monoclonal antibodies that are specific for antigens of virulent subspecies of Treponema pallidum, including pertenue, endemicum, carateum, and pallidum. If T. pallidum, the causative organism of syphilis, is present, an immunological specific binding reaction will occur between the monoclonal antibodies and antigenic sites on T. pallidum cells. A positive immunoreaction is detected directly by a variety of techniques including radioimmunoassay, fluorescent immunoassay, enzyme linked immunosorbent assay, agglutination reactions, and complement consumption tests.

U.S. Pat. No. 5,290,677 discloses a method for detecting hepatitis A virus by capturing whole virus particles with antibodies specific to hepatitis A virus. The method involves generating a cDNA copy of the RNA by reverse transcription in the presence of a primer having a predetermined sequence, amplifying the cDNA by a polymerase chain reaction, and detecting the amplified cDNA by hybridization with probes of a predetermined sequence, or by detection of label bound to the primer, wherein the presence of detectable hybridization or amplification indicates the presence of hepatitis A virus. Samples containing free virus (stool environmental samples, or other fomite associated material) may be selectively removed from adventitious material by immunoselection of whole virus using a high titer anti-HAV antibody coated onto a solid phase. The viral RNA is then denatured in the presence of specific primers, and the viral RNA is reverse transcribed to cDNA using standard methodology.

Further examples of diagnostic methods pertaining to the detection of microbial cells are disclosed in U.S. Pat. No. 6,077,665 relating to a rapid assay for infection in immunodeficient patients such as neonates or immunocompromised patients (HIV or transplant patients). The method allows diagnosis at initial evaluation such that antibiotic treatment and confinement to an intensive care unit can be avoided for uninfected patients. The assay can be used for sepsis diagnosis including the detection of bacterial, viral, or fungal colonization of the blood stream, cerebrospinal fluid (CSF), or urinary tract. The method is based on the measurement of polymorphonuclear leukocyte (PMN, neutrophil) CD11b (Mac-1, CR3) levels by flow cytometry or laser scanning microscopy in whole blood samples.

U.S. Pat. No. 5,965,354 discloses a method and immunodiagnostic test kits for diagnosing herpes simplex virus infection. The methods and kits employ type-specific or type-common antigens in a single-step assay format. The method of the invention includes the steps of i) contacting a biological sample from a human suspected of containing antibodies to herpes simplex virus with one or more purified herpes simplex virus polypeptides bound to a solid support under conditions that allow herpes simplex virus antibodies, when present in the biological sample, to bind to said herpes simplex virus polypeptides, and ii) detecting the presence or absence of bound antibodies as an indication of the presence or absence of herpes simplex virus, wherein said detecting is done by using at least one detectably labeled anti-human immunoglobulin antibody.

One of the most common presenting complaints of patients seeking medical care is for illness associated with respiratory symptoms such as runny nose, sneezing, sore throat, cough, and/or wheezing. These symptoms are usually attributable to one of the following etiologies: 1) allergic rhinitis, 2) viral infection (URI, “common cold”, viral pharyngitis, “the flu”, etc.), or 3) bacterial infection (Strep throat, sinusitis, pneumonia, etc.). During the winter months, there is a tremendous surge in viral and bacterial spread which causes patients to frequently have fever in addition to respiratory symptoms. However, due to the overlap and range of symptom severity, diagnosis of these conditions is difficult and may lead the physician to order expensive lab tests and x-rays or CT scans to clarify the etiology.

Treatment for these conditions is distinctly different, thus making accurate diagnosis imperative: 1) to avoid improper therapy (e.g. antibiotics for a viral infection or allergic rhinitis), 2) to reduce potential medication side-effects and 3) to help curb the rapid increase in antibiotic resistance. On a global scale, the rapid rise in prevalence of antibiotic-resistant strains of bacteria has been declared a public health emergency by organizations such as the Centers for Disease Control (CDC). Antimicrobial resistance is primarily due to the indiscriminant and inappropriate use of antibiotics, thus prompting the CDC to institute educational programs for both the lay public and medical professionals regarding appropriate antibiotic use.

The availability of a rapid, simple and accurate differential diagnostic method to detect the etiology of the respiratory symptoms would result in a significant improvement in the ability to accurately diagnose and appropriately treat these conditions. A rapid, accurate diagnosis provided during the patient visit would provide for appropriate therapy from the onset which would improve patient outcomes and resource utilization, thus reducing overall healthcare expenditures for one of the most common conditions encountered by in primary care. The present invention provides a system and method for providing rapid differential diagnosis whereby a patient may easily deposit biological samples in a receptacle containing an indicator device.

The present invention may be useful in the veterinary field as well as the field of human medicine. Rapid diagnosis of animal ailments is important for the well-being of pets, wild animals, and domesticated feed stock. The present invention could assume world wide significance where animal disease approaches pandemic or epidemic levels. The components, systems, and methods of the present invention apply to the entire animal kingdom.

In some embodiments a system for collecting biological samples may include a sample receptacle. At least a portion of the sample receptacle may be transparent, and a portion of the transparent portion may include a substantially planar interior surface of the sample receptacle. The sample receptacle may function to position at least a portion of an indicator in a predetermined orientation relative to the transparent planar interior surface of the sample receptacle.

In some embodiments a predetermined indicator orientation may be substantially coplanar relative to the transparent interior surface of the sample receptacle. The indicator may function to investigate the presence of an analyte in a biological sample collected in the receptacle, and provide a signal, such as a color change, to a user upon detection of an analyte. The indicator or the sample itself, may, in addition to or instead of providing a visual signal, provide, trigger, generate, or otherwise evoke responses from analysis devices independent of the present invention.

In some embodiments a receptacle is configured to position more than one indicator in a predetermined orientation relative to a transparent interior surface of the sample receptacle. The receptacle may include one or more retainers per indicator configured to position at least a portion of the indicator in a predetermined orientation relative to the transparent interior surface of the sample receptacle. The retainers may be positioned on opposing edges of an indicator, and may extend from or adjacent to a distal end of the receptacle to a proximal end of the receptacle.

In some embodiments a positioned indicator may be inhibited from moving such that at least a portion of the indicator is held in a predetermined orientation relative to the interior surface of the sample receptacle. In some embodiments a portion of the transparent portion of a sample receptacle may include an exterior surface configured to magnify a portion of the indicator when it is viewed through the exterior surface.

In some embodiments a distal portion of a sample receptacle may include a diverter configured to divert fluids to a predetermined channel. The diverter may include a raised portion extending from the center of the distal end of the indicator, the raised portion causing a sample flowing from the proximal end of the diverter to be directed down one or more sides of the diverter into the predetermined channel.

In some embodiments a system for collecting samples may include a sample director. A distal end of the director may be coupled to or integral with a proximal end of the sample receptacle. A proximal end of the director may include a first opening shaped to substantially conform to a human body opening. The distal end of the director may include a second opening in fluid communication with the receptacle. The second opening may function to direct fluids toward a distal end of the sample receptacle and away from one or more proximal interior surfaces of the receptacle.

In some embodiments the director first opening has a substantially triangular cross-section. A first opening may have a substantially triangular cross-section configured to fit over the end of a human nose. In some embodiments a first opening may have a substantially circular cross-section. In some embodiments a proximal end of a director may include a first opening shaped to substantially conform to a human body opening. The distal end of the director may include a second opening in fluid communication with the receptacle. At least the portion of the proximal end of the director may conform to the portion of the surface of the human body opening when positioned adjacent the portion of the surface such that the portion of the proximal end of the director facilitates collection of a sample.

In some embodiments the director first opening comprises at least one portion of flexible material coupled to at least one edge of the first opening. The portion of the material may be configured to direct a sample from a human body opening in the first opening of the director. Portions of material may be formed from any type of substance. Material may be rigid or pliable. Material may be hard or soft. In a particular embodiment, a portion of material may be similar to a facial tissue or a woven portion of gauze. In some embodiments a portion of material may be formed from Webril™, commercially available 100% cotton undercast padding produced by the Kendall Co. of Mansfield, Mass.

In some embodiments a system for collecting biological samples may include a base fixed to, removeably attached to, or integral with the distal end of a sample receptacle. The base may function to hold the receptacle substantially vertical when the receptacle is positioned on a substantially horizontal surface. The receptacle may also be configured so that it will rest horizontally on a horizontal surface.

In some embodiments a system for collecting biological samples may include a sample manipulator. A sample manipulator may function to assist a user in conveying sample from a director through a second opening into a receptacle.

### BRIEF DESCRIPTION OF THE DRAWINGS

FIG. 1 depicts a perspective view of one embodiment of at least a portion of a system for collecting biological samples.

FIG. 2 depicts an exploded view of FIG. 1.

FIG. 2A depicts a perspective view of one embodiment of a biological sample manipulator.

FIG. 2B depicts a perspective view of one embodiment of a biological sample manipulator.

FIG. 3 depicts a side view of one embodiment of a receptacle.

FIG. 4 depicts a cross sectional view of one embodiment of a proximal portion of a receptacle.

FIG. 5A-C depict cross sectional views of various embodiments of a distal portion of a receptacle.

FIG. 6A-E depict cross sectional views of portions of various embodiments of a receptacle.

FIG. 7 depicts a cross sectional view of a portion of one embodiment of a receptacle.

FIG. 8 depicts a cross sectional view of a portion of one embodiment of a receptacle.

FIG. 9 depicts a perspective view of one embodiment of a director.

FIG. 10 depicts a perspective view of one embodiment of a director.

FIG. 11 depicts a perspective view of one embodiment of a director.

FIG. 12 depicts a perspective view of one embodiment of a director with two portions of material attached to the proximal end of the director.

FIG. 13 depicts a side view of one embodiment of a receptacle including a closing device and a base.

FIG. 14 depicts a partially exploded perspective view of one embodiment of a receptacle including a closing device, a base, and an exposed indicator.

FIG. 15 depicts a partially exploded perspective view of one embodiment of a receptacle including a closing device, a base, and an indicator positioned inside the receptacle.

FIG. 16 depicts an exploded perspective view of one embodiment of at least a portion of a system for collecting biological samples.

FIG. 17 depicts a top view of one embodiment of a receptacle.

FIG. 18 depicts a top view of one embodiment of a receptacle.

FIG. 19 depicts a side view of a receptacle in an angled configuration.

### DETAILED DESCRIPTION OF THE INVENTION

In some embodiments of the present invention a method of diagnosing a disease may include a system including one or more different components or elements. A method may include collecting a biological sample from a subject in a receptacle. In some embodiments a method may include exposing at least a portion of a collected sample to an indicator. An indicator may provide a signal when exposed to one or more analytes.

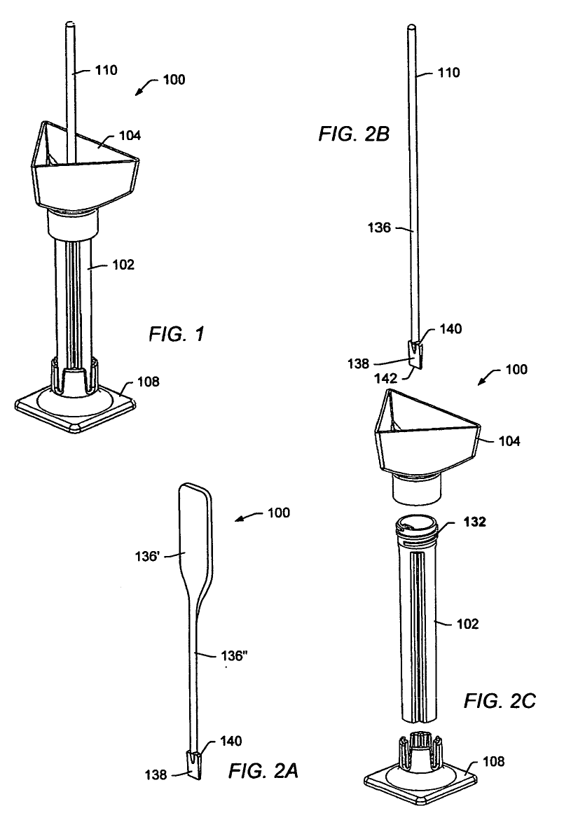

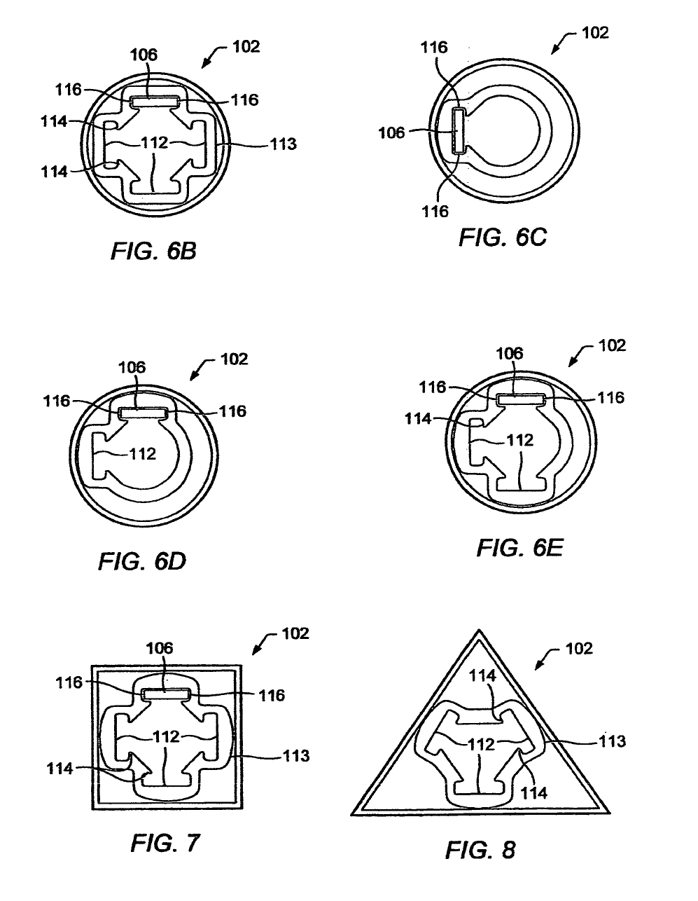

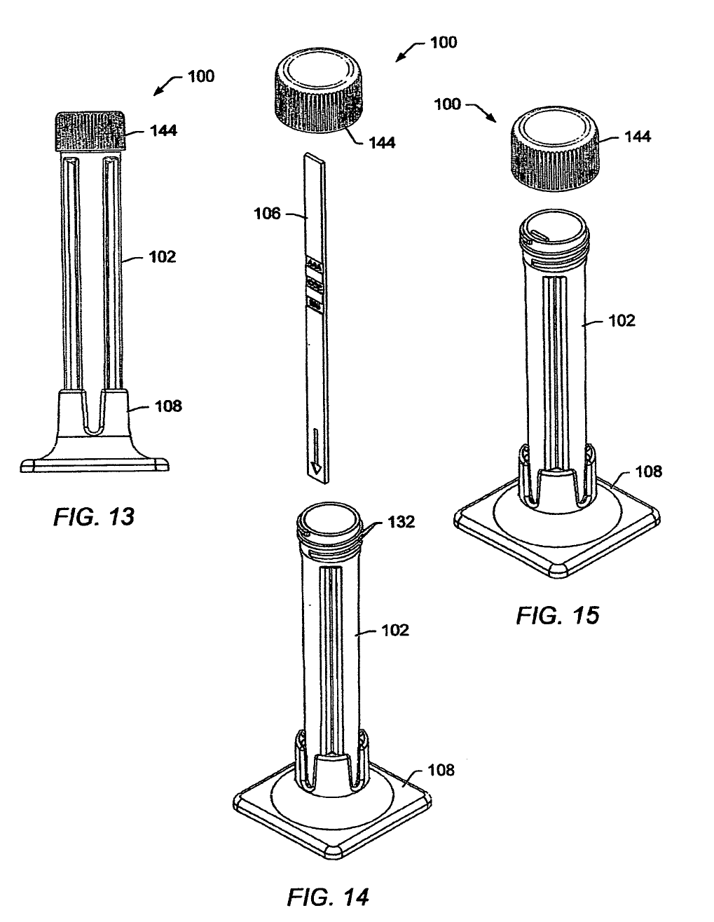

FIGS. 1 and 2 depict embodiments of at least a portion of a system for collecting biological samples. In some embodiments system 100 for collecting samples and investigating the presence of analytes may include a sample receptacle 102, a sample director 104, and at least one indicator 106 (shown in FIGS. 6A-E, 7, and 14). In some embodiments a system may include a receptacle base 108 and a sample manipulator 110. In some embodiments a system may include a cap or plug 144 (shown in FIGS. 13-15) for containing the contents of the receptacle.

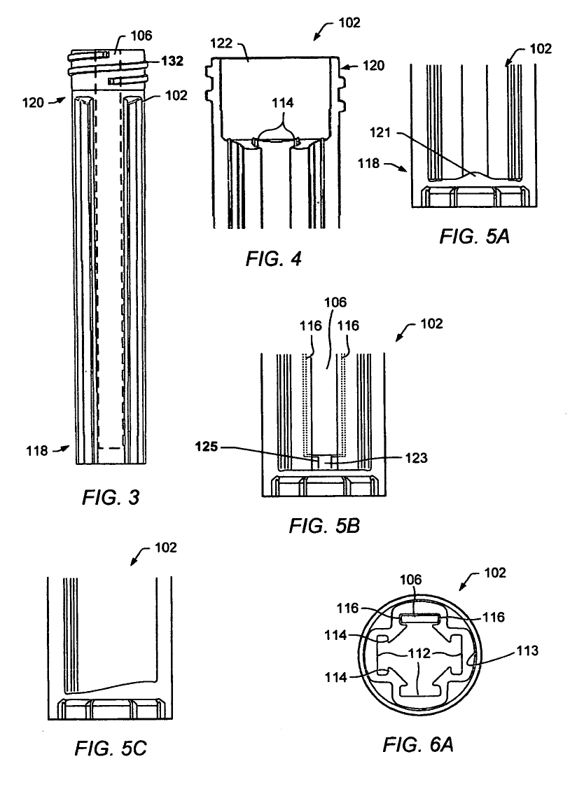

FIGS. 3-8 depict various embodiments of a receptacle. In some embodiments a system may include sample receptacle 102. Receptacle 102 may function to contain a biological sample and one or more indicators 106. All or portions of a receptacle may be substantially transparent such that a user may view at least a portion of the contents of a receptacle, including, if present, an indicator. The ability to view an indicator positioned in a receptacle allows a user to see if a visual signal has been produced by an indicator when exposed to a biological sample.

In some embodiments receptacle 102 may include an interior surface wherein portions 112 of the interior surface are substantially planar. Interior planar surface 112 may allow a user to more easily view items in a receptacle such as indicators. Interior planar surfaces may provide less distortion of items in a receptacle when viewed from outside of the receptacle. In some embodiments an interior of a receptacle may function to position an item such as an indicator within the receptacle with a specific orientation relative to a receptacle interior surface. Orienting an indicator surface relative to a planar interior surface of the receptacle may permit viewing of the indicator with minimal optical distortion.

In some embodiments at least portion 113 of an outer surface of a receptacle may be configured to optically affect the contents of the receptacle when viewed from the receptacle exterior. In some embodiments portion 113 of an outer surface of a receptacle may be configured to magnify a portion of a receptacle's contents. Portion 113 of an outer surface of a receptacle may be substantially convex such that the receptacle's contents are magnified.

In some embodiments an outer surface of a receptacle may be configured to provide a clear view of the contents of the receptacle without magnification. FIG. 6B depicts a top view of one embodiment of receptacle 102. At least portion 113 of an outer surface of receptacle 102 may be substantially planar. Portion 113 of the outer surface of receptacle 102 may be substantially parallel to interior surface 112, thereby minimizing visual distortions of the receptacle contents.

Inhibiting movement of an indicator in a receptacle may allow for the placement of multiple indicators in the receptacle in a more organized fashion such that a user may view all of the positioned indicators. Inhibiting movement of an indicator positioned in a receptacle may allow for more even and reproducible sample distribution over the indicator. Inhibiting movement of indicators in a receptacle may also inhibit cross contamination of different chemicals or agents on individual indicators. Inhibiting movement of indicators in receptacles may also allow for easier transport of samples.

In some embodiments a receptacle may include retainers 114 that function to inhibit movement of indicators positioned in the receptacle. Retainers 114 may take any form that adequately inhibits the movement of indicators once in a receptacle. Retainers may take the form of clips such as spring clips coupled to the interior surface of the receptacle. As shown in FIGS. 6A, B, E and FIGS. 7 and 8, in some embodiments retainers 114 may be formed as an integral part of receptacle 102. For example, an interior surface of the receptacle may be shaped such that a number of retainers are formed in the interior surface of the receptacle to inhibit movement of a number of indicators 106.

In some embodiments indicator 106 may include one or more strips of edge material. In such configurations a receptacle may include at least two retainers for each indicator positionable in the receptacle. As shown in FIGS. 6A-E and FIGS. 7 and 8, two retainers 114 may fit around opposing edges 116 of indicator 106, one retainer per opposing edge 116. The retainers in some embodiments may form a press fit coupling with the edge strip. The press fit coupling may allow for the indicator to be easily inserted by a user while still inhibiting movement once positioned. In some embodiments it is not absolutely necessary for the indicator to be inhibited from all movement. The fit may be only such that one face of the indicator is positioned in a predetermined orientation relative to a receptacle interior surface, and that an indicator is prohibited from contacting another indicator. FIGS. 6A, 6B, and 7 illustrate receptacle embodiments with sufficient retainers (8) to inhibit the movement of four indicators. FIGS. 6E and 8 illustrate receptacle embodiments with sufficient retainers (6) to inhibit the movement of three indicators. In some embodiments a receptacle may have no retainers. Such a system permits simple dipping of an indicator into the sample contained in a receptacle.

Retainers may fit around opposing edges of a strip in one or more pairs directly opposite one another. Positioning pairs of retainers directly opposite one another may inhibit the occurrence of unwanted deformation of an indicator during and after the indicator is positioned in a receptacle. One or more pairs of retainers may be positioned along the length of a receptacle.

In some embodiments a receptacle may include one pair of retainers per indicator. At least one pair of retainers may extend a majority of the length of a receptacle. The retainers may extend along a longitudinal axis extending from or substantially adjacent a proximal end 120 of the receptacle to or substantially adjacent a distal end 118 of the receptacle as shown in FIG. 3.

In some embodiments a receptacle may be configured to hold one, two, three, or four indicators as illustrated in, respectively, FIG. 6C, FIG. 6D, FIGS. 6E and 8, and FIGS. 6A, 6B, and 7, but the number of indicators provided for in the present invention is limited only by the receptacle length and perimeter dimensions desired by the user.

A receptacle may have any shape cross section. In some embodiments a receptacle cross section may be dictated by the size and shape of a standard laboratory test tube rack. In some embodiments a portion of a receptacle may have a circular cross section (FIGS. 6A-E), a square cross section (FIG. 7), or a triangular shape (FIG. 8).

In some embodiments a retains may include a substantially enclosed channel extending along at least a portion of an interior surface of a receptacle. The channel may include a first opening adjacent the proximal end. The first opening may allow for an indicator to be positioned in the receptacle channel. The channel may include a second opening adjacent the distal end of the receptacle. The second opening may allow sample in the interior of the receptacle to access an indicator.

In some embodiments distal end 118 of receptacle 102 (FIGS. 3 and 5A) may be configured to convey sample toward a distal end of an indicator positioned in the receptacle. Distal end 118 of receptacle 102 may include diverter 121 (FIG. 5A) that may be positioned in a substantially central location in the interior of the receptacle distal end. The diverter may be configured to divert sample toward a distal end of a positioned indicator. A diverter may include a raised portion extending from the center of the distal end of the receptacle.

A biological sample may flow from a proximal end of the diverter down one or more sides of the diverter and in at least first channel 123 (FIG. 5B). The diverter may be configured to divert sample toward one or more channels 123 at the distal end of a receptacle. FIG. 5B depicts an embodiment of a distal end of receptacle 102 with indicator 106 positioned in the receptacle. Diverter 121 depicted in FIG. 5A has been removed from FIG. 5B for illustrative purposes such that channel 123 may be more clearly depicted. A channel may be in fluid communication between a first space and a second space on either side or face of the distal end of the indicator. A distal end of a receptacle may include indicator supports 125 that, in elevating indicator 106, form channel 123 through which sample travels. Such a feature provides for maximum sample/indicator exposure.

In some embodiments distal end 118 of receptacle 102 may be configured to convey sample toward a distal end of a positioned indicator. FIG. 5C depicts a cross section of an embodiment of a distal end of receptacle 102 configured to hold one indicator as in FIG. 6C. In such an embodiment a distal interior surface of the receptacle has been shaped to divert sample toward a positioned indicator.

In some embodiments a system may include a receptacle including first opening 122 at the proximal end of the receptacle as shown in FIGS. 4, 16, and 17. First opening 122 may be configured to accept one or more indicators and/or one or more biological samples.

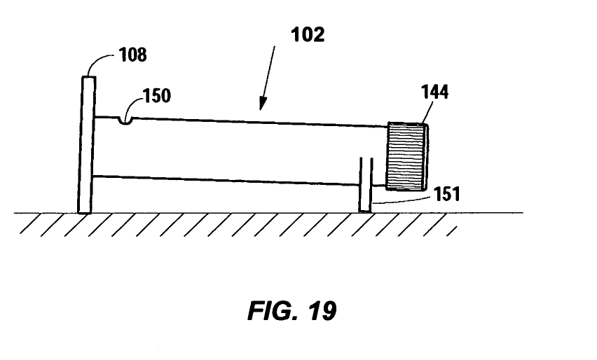

In some embodiments the receptacle may be configured to rest horizontally or at some angle between horizontal and vertical. For example, FIG. 19 shows a tubular receptacle 102 with integral square base 108, cap 144, and integral protrusion or leg 151 the length of which may be selected so as to provide a predetermined angle of the receptacle longitudinal axis with the surface on which the receptacle rests. The receptacle of FIG. 19 contains an indicator (not shown) that was inserted prior to installation of cap 144. The receptacle could contain previously deposited sample. Or the sample or a wash such as a reagent, catalyst, or diluting agent could be introduced into the receptacle through an opening 150 that communicates with the interior of the receptacle. If necessary, opening 150 could be closed with tape or epoxy for a temporary or permanent seal.

A director 104 may direct sample toward the interior sides of a receptacle such that some of the sample contacts the distal end of an indicator. This feature is advantageous because it negates the need for sample dilution that can decrease indicator accuracy.

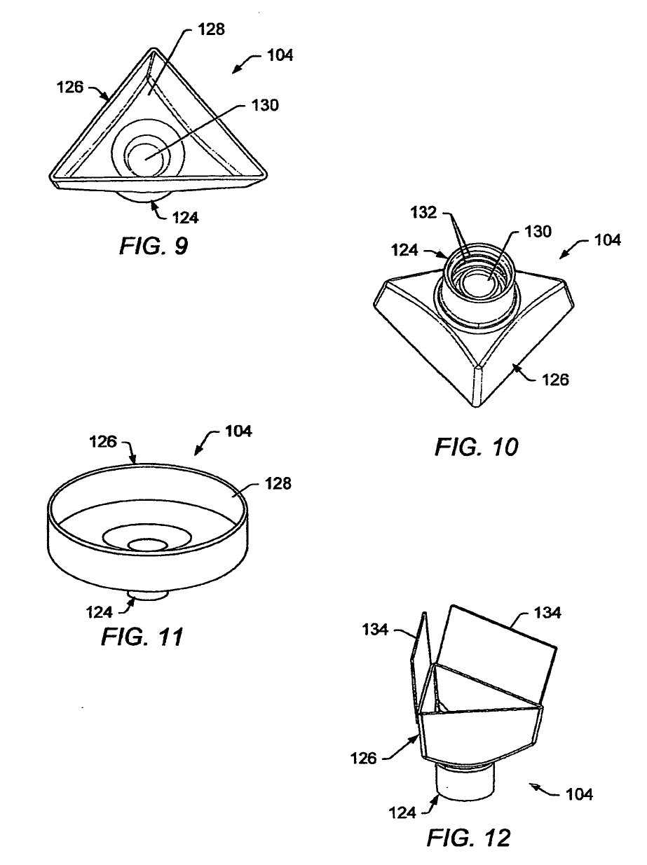

FIGS. 9-12 depict various embodiments of directors 104 that may be part of some embodiments of the present invention. Distal end 124 of director 104 may couple to proximal end 120 of receptacle 102. Proximal end 126 of director 104 may include first opening 128, and distal end 124 of director 104 may include a second opening 130. The first opening may be in fluid communication with the second opening, and the second opening may be in fluid communication with the receptacle. The director's first opening may have a larger area than the second opening, thus offering properties of a funnel. Directors may facilitate the introduction of samples into receptacles, particularly where receptacles are small, such as where receptacles are similar in size to common laboratory test tubes. A director with a large proximal opening will facilitate transfer of a sample from a human body opening to a small receptacle.

A director may couple to a receptacle in several ways commonly understood in industry. In some embodiments a director may be coupled to a receptacle via a press-fit, a threaded fitting 132 as in FIGS. 2, 3, 14, and 16, or other frangible couplings. A frangible coupling between a receptacle and a director may permit removal of the director after a sample has been collected. In other embodiments a director may be formed as an integral part of or ultrasonically welded to the receptacle.

In some embodiments a director may be configured to couple to any number of known containers produced within the medical field. A director, as with all of the individual components described herein, may be configured to work with other known systems. A director second opening may be configured to couple to, for example, known media containers and testing kits.

A first opening may be formed in any shape to facilitate the collection of samples. In some embodiments a director proximal end may include a first opening shaped to substantially conform to a human body opening. In some embodiments a first opening may have an approximately triangular cross-section as depicted in FIGS. 9, 10 and 12. A triangular opening may conform to the nose of a human subject. In some embodiments such as FIG. 11 a first opening may have a substantially circular shape for conformance to a body opening such as a mouth, particularly when a patient is required to spit in a receptacle for acquisition of a saliva sample. A first opening in the proximal end of a director may be formed from a pliable or flexible material so that a user may conform and reconform the first opening shape. A flexible first opening permits a user to shape the first opening in the manner most advantageous for collection of samples.

In some embodiments a second opening of the distal end of a director may function to direct a sample deposited in a director toward or away from a particular area of a receptacle. The second opening of the distal end of a director may be off-center relative to an opening in the proximal end of a receptacle or director. Off setting the second opening may facilitate directing a sample deposited in the first opening of the director toward a portion of the receptacle to which the director is coupled.

In some embodiments a second opening of a distal end of a director may extend into an opening in a proximal end of a receptacle, thus channeling sample away from interior receptacle surfaces and toward a distal end of a receptacle. Channeling a sample toward a distal end of a receptacle may result in advantages such as higher sample concentration resulting in more accurate and reproducible tests.

In some embodiments a director may have one or more portions of a pliable material 134 coupled to a portion of the director. A portion of material 134 may be coupled to proximal end 126 of director 104 as in FIG. 12. A portion of material coupled to a director may facilitate introduction of sample into a director. In embodiments of a system for collecting samples such as mucus from a human nasal cavity, a portion of material may be formed from a soft pliable material such as or similar to facial tissue.

In some embodiments a portion of material may be formed from a substance that may be easily torn from or removed from a director. The portion of material may have a frangible link coupling a distal portion of the material to the proximal end of the director. In some embodiments a portion of such material may be directly coupled to a receptacle.

Some embodiments of the present invention may be reusable. For example, a director design may permit the coupling of a portion of pliable material. A system for coupling a portion of material to a director may allow more than one portion to be used if a first portion is damaged during a first attempt at sample collection. For example, a subject may use a first portion of material to collect a first sample of nasal mucus, disengage or decouple and discard the first portion of material, couple a second portion of material to the director, and collect a second sample. Such a coupling system may allow over the counter facial tissues to be used as the pliable material. In some embodiments a system for coupling a portion of material may include one or more clips including, but not limited to spring clips and friction clips. Tape or adhesive may also be used to secure portions of material to a director. In some embodiments the pliable material may include multiple layers. A first layer may provide pliable strength, and a second layer may be formed from a material softer than the first layer. In some embodiments portions of pliable material may couple with tape or other removeable attachment means to a seating area such as a toilet seat.

In some embodiments a system as described herein may be sold as a kit. A kit for the collection and/or detection of analytes may include multiple different versions of a director. The kit may include directors with different sized and/or shaped first openings to accommodate collection of different types of samples in various manners from human subjects.

In some embodiments a director may be formed from more than one type of material, each material having distinctive properties. For example, the first opening of the proximal end of a director may be formed from a pliable material such that the shape of the first opening may be conformable. A second opening of a distal end of a director may be formed from a more rigid material. A substantially rigid distal end of a director may facilitate coupling of the director to a receptacle.

FIGS. 1-2A depict embodiments of sample manipulator 110 that may be part of an embodiment of system 100 used for collecting samples. Sample manipulator 110 may assist a user in the conveyance of a sample through a director second opening into a receptacle. A manipulator may include a grasping handle 136 and a conveyor 138 coupled to the distal end of handle 136. A conveyor may function to move a portion of a sample through a director second opening into a receptacle. In some embodiments a manipulator may be long enough to enable a user to agitate a receptacle's contents located at a receptacle's distal end.

In some embodiments conveyor 138 may taper down from a first thickness at proximal end 140 to an edge at distal end 142. Proximal end 140 may be substantially inflexible. Distal end 142 may be pliable. A distal end may be pliable such that as the distal end is pressed against a surface the distal end may substantially conform to the shape of the surface to which the distal end is pressed. The distal end may conform to the surface to which it is pressed such that the conveyor more efficiently moves samples along the surface. A conveyor may or may not be formed of one material in order to achieve the difference in the flexibility between the distal and proximal ends of the conveyor.

In some embodiments a handle of a manipulator may be configured for a user to grasp the handle more securely. The handle may have a wide flat portion of textured surface at a proximal end of the handle. FIG. 2A depicts an embodiment of sample manipulator 110 with enlarged handle portion 136′. The enlarged handle may facilitate a user grasping and using the sample manipulator. Second handle portion 136″ may have physical dimensions allowing the second handle portion to fit within sample receptacle 102 such that a user may agitate the contents of the sample receptacle using conveyor 138. In some embodiments second handle portion 136″ may be long enough to allow conveyor 138 to reach a distal end of sample receptacle 102 even in embodiments where enlarged handle portion 136′ has a diameter that inhibits the enlarged handle portion from entering an opening in the proximal end of the receptacle. In some embodiments second handle portion 136″ may have a diameter of about ⅛ inches, and enlarged handle portion 136′ may have a diameter of about two or more times as large as the second handle portion.

FIGS. 1, 2, and 13-15 depict embodiments of receptacle base 108. In some embodiments a system for collecting samples may include a base 108 for stabilizing a receptacle when it is put on a surface such as a table. In some embodiments a base may be coupled to a distal end of a receptacle. A base may help to stabilize a receptacle such that a centroid longitudinal axis of a receptacle forms a predetermined angle with respect to a surface upon which the receptacle rests. Typically a predetermined angle will be approximately 90 degrees.

In some embodiments a receptacle may have a distal end that allows a receptacle to be positioned on a surface without the use of a base. A distal end of a receptacle may be substantially flat such that the receptacle may stand erect. A distal end of a receptacle may include one or more portions that function in combination to hold a receptacle in an upright configuration.

Although in some embodiments a receptacle may be freestanding, the receptacle may lack stability. In some embodiments a base with a greater diameter than the receptacle's distal end may be coupled to the receptacle. The base may be coupled to a receptacle in any way known to one skilled in the art. For example, a base may couple to a receptacle with a press fit, friction fit, or threaded coupling. A base may also be integral with or ultrasonically welded to a receptacle.

FIGS. 13-15 depict embodiments of closing device 144. In some embodiments a system for collecting samples may include closing device 144 that, when in place, may inhibit anything from entering or exiting a receptacle before or after sample collection. A closing device may include various styles of a cap, lid, or plug. In some embodiments a cap may couple to a proximal end of a receptacle substantially sealing the receptacle. A cap may couple to a receptacle via threaded coupling 132. A cap may also couple to a receptacle via a friction or snap fit coupling.

In some embodiments a system for collecting samples may include a flushing fluid container. A flushing fluid may be employed to rinse a sample from a director into a receptacle or to dilute a sample in a receptacle. It may be beneficial to dilute a sample such that the sample may be more easily conveyed along an indicator. In a system packaged as a kit, one or more single use containers of flushing fluid may be included. Flushing fluids may be contained in ampoules or other containers known to one skilled in the art. In some embodiments a kit may include a container with multiple doses of flushing fluids. In some embodiments flushing fluids may include water or a saline solution.

Systems for collecting samples may include configurations for collecting any type of sample. Many previously mentioned examples and embodiments have focused on the collection of mucus; however, these embodiments should not be seen as limiting. Other embodiments may be configured to collect urine or stool samples. Current systems for collecting urine and stool systems have many limitations. Most current systems are simply small plastic containers with some type of lid. Problems arise for users who typically are trying to squat over a toilet while holding the plastic container properly so that the user may collect a sample without making a mess. What is needed is a system for collecting stool and urine samples which is hands free.

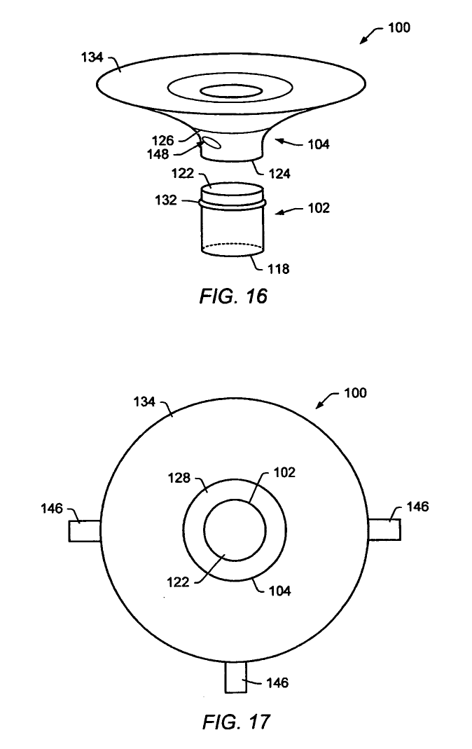

FIG. 16 depicts an exploded view of an embodiment of at least a portion of system 100 for collecting samples. FIG. 17 depicts a top view of an embodiment of receptacle 102 and director 104. The embodiment depicted in FIGS. 16 and 17 may function in assisting a user in collecting a urine or stool sample. The embodiment depicted in FIGS. 16 and 17 may include many of the same or similar components depicted in, for example, FIGS. 1-15.

A receptacle configured to receive urine or stool sample may include physical dimensions different from a receptacle that functions to collect mucus. Receptacle 102 depicted in FIGS. 16 and 17 may have a diameter of about 2 to 8 inches, about 3 to 6 inches, or about 4 to 5 inches. Receptacle 102 may have a height of about 2 to 8 inches, about 3 to 6 inches, or about 4 to 5 inches. The embodiment of receptacle 102 depicted in FIGS. 16 and 17 has a substantially circular cross section. This embodiment should not be seen as limiting; a receptacle may have any number of possible cross section shapes including, but not limited to square, rectangular, oval, and irregular.

FIGS. 16 and 17 depict an embodiment of director 104. Distal end 124 of director 104 may couple to the proximal end of sample receptacle 102. Proximal end 126 of director 104 may include a first opening 128 and a second opening in fluid communication with the first opening. The second opening may be in fluid communication with the receptacle. The first opening may have a greater diameter than the second opening.

In some embodiments a portion of system 100 for collecting samples may include overflow release opening 148. Release opening 148 may allow a user to discard any excess sample from a receptacle. A user may deposit a sample quantity that overfills a receptacle such that the sample partially fills the director. In such cases it may be difficult for a user to cleanly disconnect the director from the receptacle.

A release opening may be positioned in a director such that when the director is coupled to a receptacle, the release opening is just above the top of the receptacle. After a user has deposited a sample in the receptacle the user may remove a self adhesive strip covering the release opening to allow any excess fluids to drain into a toilet or other appropriate receptacle, thus enabling a clean director/receptacle disconnect.

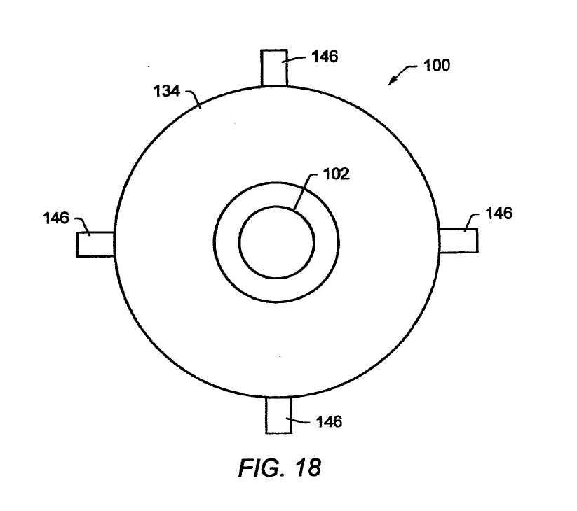

FIG. 18 depicts a top view of an embodiment of a receptacle/director combination. In this embodiment a receptacle and a director may be formed as a single piece. The system may be formed from a single sheet of pliable material that is couplable to a toilet seat. In some embodiments receptacle 102 may be a depression in the center of portions of material 134 functioning to collect urine samples.

In some embodiments a portion of material may have an outer perimeter which has a shape that conforms to one or more common shapes of toilet seats and/or bed pans. Shapes for the portions of material may include a circle and/or oval.

In some embodiments a portion of material may include two or more couplers 146 that function to couple the portion of material to a surface such as a toilet seat. Couplers 146 may include self-adhesive strips. Self-adhesive strips may include removable covers which inhibit the strips from adhering to anything before they are needed.

In some embodiments a stool sample may be collected in the present invention, wherein a disposable sample collector (e.g., a plastic spoon) may be used to collect the sample and place it in a separate receptacle, with or without the sample collector. The sample would then be ready for remote analysis.

The components of the present invention may be formed from any suitable material known to one skilled in the art. A disclosed system may be disposable, designed for a single use, and may be provided pre-sterilized in sterile packaging. Components may be formed from material that can be autoclaved, such as, for example, glass, plastic, or composite materials, depending upon the required characteristics of the particular component. Components may be formed from flame-retardant materials and materials robust enough to withstand the stresses associated with transportation such as temperature extremes and vibration. Components may be made from biocompatible and recyclable materials, as well as transparent materials that may permit visual inspection of interior spaces, surfaces, or components.

Thermoplastic injection molding is but one feasible manufacturing method available for receptacles and other elements of the present invention. There are numerous thermoplastics available that are biocompatible, transparent, strong, and possessive of good molding characteristics.

In some embodiments a system for collecting biological samples may include one or more indicators. Indicators may function to detect one or more analytes. An indicator for use in the present invention may be of any type. An indicator may include a flow detection device. In some embodiments an indicator may include an immunological test strip. An indicator may be of any shape and dimension, but in some common embodiments is a rectangular strip.

Some indicators produce a signal when exposed to a particular analyte. The signal may be a visual signal or it may be, for example, the digital, audible, or spectroscopic output of a forensic test. At least a portion of an indicator may change color when exposed to an agent.

An indicator may include, at least in part, any absorbent or non-absorbent material. Materials may include nylon, paper, glass fiber, dacron, polyester, nitrocellulose, polyethylene, olefin, or other thermoplastic materials such as polyvinyl chloride, polyvinyl acetate, copolymers of vinyl acetate and vinyl chloride, polyamide, polycarbonate, polystyrene, etc. In some embodiments at least one indicator may be nitrocellulose having a pore size of at least about 1 micron, greater than about 5 microns, or about 8-12 microns. Suitable nitrocellulose sheets having a nominal pore size of up to approximately 12 microns, are available commercially from, for example, Schleicher and Schuell GmbH.

In some embodiments an indicator may include one or more materials. In embodiments wherein an indicator includes two or more materials, two or more of the materials may be in fluid communication. One material of an indicator may be overlaid on another material of an indicator, such as for example, filter paper overlaid on nitrocellulose. An indicator may include a region including one or more materials followed by a region including one or more different materials. In some cases, the regions are in fluid communication and may or may not partially overlap one another.

The material or materials of an indicator may be bound to a support or solid surface such is found, for example, in thin-layer chromatography, and may include an absorbent pad either as an integral part or in liquid contact. For example, an indicator may include nitrocellulose sheet backed, for example, with a supporting sheet such as a plastic sheet, to increase its handling strength.

In some embodiments an indicator may include one or more areas. An indicator may include a sample application area and a test results assessment area. The test results assessment area may include one of more analyte detection areas and one or more control areas. In some embodiments an indicator may include a reagent area.

At least one specific binding member in the test results assessment area of an indicator may be impregnated throughout the thickness of the absorbent or non-absorbent material in the test results assessment area. For example, specific binding members for one or more analytes may be impregnated throughout the thickness of an indicator material in one or more analyte detection areas. Specific binding members for one or more control analytes may be impregnated throughout the thickness of an indicator material in one or more control areas. Such impregnation can enhance the extent to which the immobilized reagent can capture an analyte present in the migrating sample. Alternatively, reagents including specific binding members and components of signal producing systems may be applied to the surface of the absorbent or non-absorbent material. Impregnation of specific binding members into indicator materials or application of specific binding members onto indicator materials may be accomplished manually or mechanically.

The analytes may be applied to the carrier material in a variety of ways. Various techniques have previously been proposed for application of liquid analytes to carriers, for example micro-syringes, pens using metered pumps, direct printing and ink-jet printing, and any of these techniques may be used in the present context. To facilitate manufacture, the carrier may be treated with the analytes and then subdivided into smaller portions to provide a plurality of identical carrier units.

In embodiments where the analyte is detected by a signal producing system, such as by one or more enzymes that specifically react with the analyte, one or more components of the signal producing system may be bound to the analyte detection area of an indicator material in the same manner as specific binding members are bound to an indicator material. Components of the signal producing system that are included in the sample application area, the reagent area, or the analyte detection area of an indicator, or that are included throughout an indicator, may be impregnated into one or more materials of an indicator.

Indicators may be purchased commercially from Quidel Corporation in San Diego, Calif. (e.g., QuickVue).

The following studies demonstrate the prevalence of infections, especially among children, and how, absent dependable test methods, common symptoms make accurate diagnosis difficult:

Chung et al., “Detection of viruses identified recently in children with acute wheezing”, J. Med. Virol. 2007 Jun. 27, 79(8) pgs. 1238-1243.

de Roux et al., “Viral community-acquired pneumonia in nonimmunocompromised adult,”Chest. 2004 Apr. 125 (4): 1341-51.

Jennings et al., “Incidence and Characteristics of Viral Community-Acquired Pneumonia in Adults,” online, Jun. 15, 2007.

Weigl et al., “Ten years' experience with year-round active surveillance of up to 19 respiratory pathogens in children,” Eur. J. Pediatr. Jun. 14, 2007 (published online).

Griffin et al., “Epidemiology of respiratory infections in young children: insights from the new vaccine surveillance network”, Pediatr Infect Dis. J. Nov. 2004 23(11 Suppl): S188-92.

Ko et al., “A 1-year prospective study of the infectious etiology in patients hospitalized with acute exacerbations of COPD,” Chest. Jan. 2007 131(1): 44-52.

Groenewegen et al., “Bacterial infections in patients requiring admission for an acute exacerbation of COPD; a 1-year prospective study“, Respir Med. 2003 Jul.; 97(7): 770-7.

Wilson et al., “Effect of sputum bacteriology on the quality of life of patients with bronchiectasis”, Eur Respir J. 1997 Aug.; 10(8): 1754-60.

Herein certain U.S. patents, U.S. patent applications, and non-patent publications have been incorporated by reference. The text of such materials is only incorporated by reference to the extent that no conflict exists between such citations and the present specification and drawings set forth herein. The text of any such conflicting materials is specifically not incorporated herein.

It will be apparent to those with ordinary skill in the relevant art having the benefit of this disclosure that the present invention provides systems and methods for collecting biological samples and investigating them for the presence of analytes. It is understood that the forms of the invention shown and described in the detailed description and the drawings are to be taken merely as the currently preferred embodiments, and that the invention is limited only by the language of the claims. The drawings and detailed description presented herein are not intended to limit the invention to the particular embodiments disclosed. While the present invention has been described in terms of a few preferred embodiments, it will be apparent to those skilled in the art that form and detail modifications can be made to the described embodiments without departing from the spirit or scope of the invention.

What is claimed is:

1. A sample receptacle comprising an interior and exterior surface and proximal and distal ends wherein the receptacle is configured to at least partially contain a sample and position at least a portion of an indicator having proximate and distal ends in a predetermined orientation relative to the interior surface of the receptacle.

2. A sample director comprising a container having proximal and distal ends and a first opening at the proximal end configured to substantially conform to one or more animal body openings.

3. The director of claim 2 wherein the director opening has a substantially circular cross-section.

4. The director of claim 2 wherein the director opening has a substantially triangular cross-section.

5. The director of claim 2 wherein the director opening has a substantially rectangular cross-section.

6. The director of claim 2 wherein the director opening has a substantially square cross-section.

7. The director of claim 2 wherein the director opening has a substantially oval cross-section.

8. The director of claim 2 wherein the director opening has a substantially pear-shaped cross-section.

9. The director of claim 2 wherein the director opening has a substantially multi-sided cross-section.

10. The director of claim 2 wherein at least a portion of the director opening has attached to it at least one piece of flexible material configured to assist in directing a sample from an animal body opening into the director.

11. The director of claim 10 wherein the director opening is configured to substantially conform to the geometry of a toilet seat and that further comprises a means of removeable attachment to a toilet seat.

12. The director of claim 2 wherein the distal end of the director is configured to be coupled to the proximal end of a receptacle, and wherein the distal end of the director comprises a second opening in fluid communication with a predetermined section of the interior surface of the receptacle.

13. The director of claim 2 further comprising an overflow outlet.

14. The receptacle of claim 1 wherein at least a portion of the receptacle is transparent.

15. The receptacle of claim 14 wherein the receptacle magnifies at least a portion of the indicator using an exterior surface of the transparent portion of the receptacle.

16. The receptacle of claim 1 further consisting of a raised interior area near to or in the center of the receptacle distal end whereby sample is diverted from the raised area to the outer areas of the distal end of the interior of the receptacle, and wherein the distal end of a positioned indicator communicates with the outer areas of the distal end of the interior of the receptacle.

17. The receptacle of claim 14 further comprising at least one receptacle protrusion configured to permit the receptacle to rest in a predetermined substantially nonvertical position on a predetermined surface.

18. The receptacle of claim 17 further comprising an opening positioned between the receptacle proximal and distal ends wherein the opening provides external communication with at least a portion of the receptacle interior surface.

19. A manipulator configured to assist a user in positioning at least a portion of one or more indicators in a predetermined orientation relative to the interior surface of a receptacle.

20. A manipulator configured to assist a user in conveying sample through the director into the receptacle.

21. A manipulator configured to extract and introduce sample.

22. A system comprising:
a sample receptacle comprising an interior and exterior surface and a proximal and a distal end wherein the receptacle is configured to at least partially contain a sample and position at least a portion of an indicator in a predetermined orientation relative to the interior surface of the receptacle; and
a sample director wherein a distal end of the director is configured to be coupled to the proximal end of the receptacle, and wherein the proximal end of the director comprises a first opening and the distal end of the director comprises a second opening in fluid communication with a predetermined section of the interior surface of the receptacle.

23. The system of claim 22 wherein the director is integral with the receptacle.

24. The system of claim 22 wherein the director is fixed to the receptacle.

25. The system of claim 22 wherein the director is removeably attachable to the receptacle.

26. The system of claim 22 further comprising a device that removeably attaches to and substantially closes the proximal end of the receptacle.

27. The system of claim 22 wherein the director first opening is configured to substantially conform to one or more animal body openings.

28. The system of claim 22 wherein the director first opening has a substantially circular cross-section.

29. The system of claim 22 wherein the director first opening has a substantially triangular cross-section.

30. The system of claim 22 wherein the director first opening is substantially configured to accommodate the nose of an animal.

31. The system of claim 22 wherein at least a portion of the director first opening has attached to it at least one piece of flexible material configured to assist in directing a sample from an animal body opening through the director first opening.

32. The system of claim 22 wherein the director first opening is configured to substantially conform to the geometry of a toilet seat and that further comprises a means of removeable attachment to a toilet seat.

33. The system of claim 22 wherein the director second opening directs sample toward the distal end of the receptacle and away from one or more proximal interior surfaces of the receptacle.

34. The system of claim 22 further comprising a base fixed to the distal end of the receptacle wherein the base is configured to hold the receptacle in a substantially vertical position in which the receptacle's proximal end is above its distal end when the receptacle rests on a substantially horizontal surface.

35. The system of claim 22 further comprising a base removeably couplable to the distal end of the receptacle wherein the base is configured to hold the receptacle in a substantially vertical position in which the receptacle's proximal end is above its distal end when the receptacle rests on a substantially horizontal surface.

36. The system of claim 22 further comprising at least one receptacle protrusion configured to permit the receptacle to rest in a predetermined substantially nonvertical position on a predetermined surface.

37. The system of claim 35 further comprising a receptacle opening positioned between the receptacle proximal and distal ends wherein the opening provides external communication with at least a portion of the receptacle interior surface.

38. The system of claim 22 further comprising a sample manipulator configured to assist a user in conveying sample through the director into the receptacle.

39. The system of claim 22 further comprising at least one indicator positionable in the receptacle wherein at least one of the indicators is positioned in the area of fluid communication between the second opening of the director and the distal end of the receptacle, and wherein at least one of the indicators is configured to investigate the presence of at least one analyte in a sample collected in the receptacle and provide a signal upon analyte detection.

40. The system of claim Error! Reference source not found.39 wherein the signal comprises a visual signal.

41. The system of claim 39 wherein the signal comprises a color change in at least a portion of the indicator.

42. The system of claim 39 wherein the signal results from indicator examination with commonly understood laboratory techniques.

43. The system of claim 39 wherein the signal results from sample examination with commonly understood laboratory techniques.

44. The system of claim 22 wherein at least a portion of the receptacle is transparent.

45. The system of claim 44 wherein at least a portion of the transparent portion comprises a substantially planar interior surface of the receptacle.

46. The system of claim 44 wherein the predetermined orientation comprises a substantially coplanar orientation of a portion of the indicator relative to the transparent interior surface of the receptacle.

47. The system of claim 44 wherein the receptacle further comprises at least one retainer per indicator configured to position at least a portion of one or more indicators in a predetermined orientation relative to the transparent interior surface of the receptacle.

48. The system of claim 44 further comprising a manipulator configured to assist a user in positioning at least a portion of one or more indicators in a predetermined orientation relative to the transparent interior surface of the receptacle.

49. The system of claim 44 wherein the receptacle magnifies at least a portion of the indicator using an exterior surface of the transparent portion of the receptacle.

50. The system of claim 22 wherein the receptacle further consists of a raised interior area near to or in the center of the receptacle distal end whereby sample is diverted from the raised area to the outer areas of the distal end of the interior of the receptacle, and wherein the distal end of a positioned indicator communicates with the outer areas of the distal end of the interior of the receptacle.

51. The system of claim 22 wherein the director further comprises an overflow outlet.

52. A method comprising:
positioning an indicator in a sample receptacle wherein at least a portion of the receptacle is transparent, and wherein at least a portion of the transparent portion comprises a substantially planar interior surface of the receptacle; and
inhibiting the positioned indicator from moving such that at least a portion of the indicator is held in a predetermined orientation relative to the transparent planar interior surface of the receptacle.

53. The method of claim 52 further comprising magnifying at least a portion of the indicator using an exterior surface of the transparent portion of the receptacle.

54. A method comprising:
positioning an indicator in a sample receptacle wherein at least a portion of the receptacle comprises a substantially planar interior surface of the receptacle;
inhibiting the positioned indicator from moving such that at least a portion of the indicator is held in a predetermined orientation relative to the planar interior surface of the receptacle;
diverting at least a portion of a sample from a central area of the distal end of the interior of the receptacle to the outer areas of the distal end of the interior of the receptacle wherein the distal end of a positioned indicator communicates with the outer areas of the distal end of the interior of the receptacle; and
channeling at least a portion of the sample from a first face of the indicator to the opposite face of the indicator using a first channel wherein the first face is oriented toward the central area of the distal end of the interior of the receptacle.

55. A method comprising:
positioning proximate an animal body opening a first opening of a director wherein the first opening is shaped to substantially conform to the animal body opening, and wherein the director's second opening is coupled to a receptacle;
transferring a sample from the animal body opening through the director's first and second openings into the receptacle; and
directing at least a portion of the sample toward a distal end of the receptacle and away from one or more proximal interior surfaces of the receptacle.

56. The method of claim 55 further comprising:
positioning proximate an animal body opening at least a portion of flexible material attached to the director first opening, and
channeling at least a portion of the sample along the portion of material from the animal body opening to the first opening of the director.

57. The method of claim 55 further comprising using a distal portion of a manipulator to move at least a portion of the sample toward a predetermined section of the receptacle.

58. The method of claim 55 further comprising using a distal portion of a manipulator to move at least a portion of the indicator toward a predetermined position.

59. The method of claim 55 further comprising:
positioning at least a portion of an indicator in the receptacle; and
using the indicator to investigate the presence of at least one analyte in a sample.

60. The method of claim 55 wherein the director further comprises an overflow outlet.

61. The method of claim 55 further comprising:
positioning proximate a toilet seat a first opening of a director;
removeably attaching the director to the toilet seat; and
seating a person on the toilet seat.

62. The method of claim 61 further comprising:
positioning at least a portion of an indicator in the receptacle; and
using the indicator to investigate the presence of at least one analyte in a sample.
